(19) United States
(12) Patent Application Publication
(10) Pub. No.: US 2006/0138921 A1
(43) Pub. Date: Jun. 29, 2006

(54) Connecting means for lamp elements

(76) Inventors: Christoph Klein, Arnsberg (DE); Rudolf Niggemann, Arnsberg (DE)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/100,345

(22) Filed: Apr. 6, 2005

(30) Foreign Application Priority Data
Apr. 6, 2004 (DE) DE102004016817.2

(51) Int. Cl. H01J 7/24

(52) U.S. Cl. 313/10

(57) ABSTRACT

The invention concerns lamp elements which bear against each other at a separation plane and which can be releasably connected by way of a connecting means. To permit simple fixing of the lamp elements even in the overhead assembly procedure and to reduce the assembly time it is proposed in accordance with the invention that the lamp elements are each provided with respective contact pressure faces 22 and that the connecting means includes a bridge-like clamping portion 30 which in the installation position spans over the separation plane and has clamping contact pressure faces 32, 34 which in the installation position bear against the contact pressure faces 22 of the lamp elements (FIG. 3).

The invention concerns lamp elements which bear against each other at a separation plane and which can be releasably connected together by way of a connecting means. The term lamp elements includes lamp housings and other lamp system components which are connected to a lamp housing such as for example a head portion which is to be fixed to the head end of a lamp housing, a node point for the angular connection of a plurality of lamp housings to each other, and the like.

On occasions a centering means is provided between the lamp elements which bear against each other, the centering means preventing unwanted displacement of the lamp elements in relation to each other; for example a pin which projects through both lamp elements or a tongue-and-groove connection provided between the lamp elements.

In the course of assembly, a screw is screwed in between the two contact surfaces which bear against each other, in the longitudinal direction of the lamp elements, to fix the two lamp elements relative to each other. That connecting procedure is relatively complicated and expensive, in particular because manual screwdrivers and battery-powered screwdrivers cannot be used because of the restricted space in the lamp elements. With the cross-sections of the lamp bodies becoming progressively smaller, for example 30 mm×30 mm, the screws can be screwed into place in the longitudinal direction only with difficulty. In order to prevent the lamp elements from bending away from each other at the separation plane, the screws are arranged as far as possible at the lower end—as viewed from above—of the lamp elements. That causes additional difficulty in assembly as an assembly operator is required to gain access into the lamp elements from above.

Based on that state of the art, the object of the invention is to at least partially avoid those disadvantages and to permit easy fixing of the lamp elements even in the overhead assembly situation and to reduce the assembly time.

According to the invention that object is attained in that the lamp elements are each provided with contact pressure faces and that the connecting means is in the form of a bridge-like clamping portion which in the installation position spans over the separation plane and has clamping contact pressure faces which in the installation position bear against the contact pressure faces of the lamp elements.

Upon assembly the two lamp elements are thus only pressed against each other and the clamping portion is fitted on to the two lamp elements in such a way that it bridges over the separation plane and the clamping contact pressure faces bear against the contact pressure faces of the lamp elements. The crucial consideration in that respect is that, in the installation position, the clamping portion produces a press fit between the lamp elements. That can be effected either by suitable dimensioning or by the choice of material for the clamping portion itself.

Preferably in the installation position clamping contact pressure faces extend as far as the lower end of the lamp elements to be connected, in order to prevent them from bending open at the separation plane.

Assembly is additionally simplified if the contact pressure faces of the lamp elements and the clamping contact pressure faces are of a corresponding configuration such that the clamping portion pulls the lamp elements together in the assembly procedure. That can be achieved for example by the contact pressure faces prismatically widening downwardly—in the direction in which the clamping portion is pushed on—and by the spacing of the clamping contact pressure faces correspondingly prismatically narrowing in the direction in which the clamping portion is pushed on. The cross-sectional area of the opening between the clamping contact pressure faces and the connecting limb joining same is accordingly trapezoidal; the contact pressure faces of the lamp elements, when put together, form a truncated pyramid.

The two lamp elements which bear against each other are fixedly braced to each other and pressed against each other by the clamping portion being fitted thereon or pushed thereon. The particular advantage of the clamping portion according to the invention is that it can be fitted in the transverse direction relative to the lamp and to the separation plane. Accordingly the clamping portion can easily be fitted from above on to the lamp elements to be connected. In an advantageous development the clamping portion can be fixed in a ready pre-assembled condition to one of the lamp elements so that, for fixing the two lamp elements, the clamping portion only then has to be pressed down. That can be effected for example by a stirrup member in which the clamping portion is displaceably accommodated.

A particularly stable connection can be afforded if the clamping portion is made from a material with a high level of tensile strength, for example a tough steel alloy; 42CrMo4 has proven to be particularly advantageous.

The invention is described hereinafter by means of a preferred embodiment, with reference to the accompanying drawings in which:

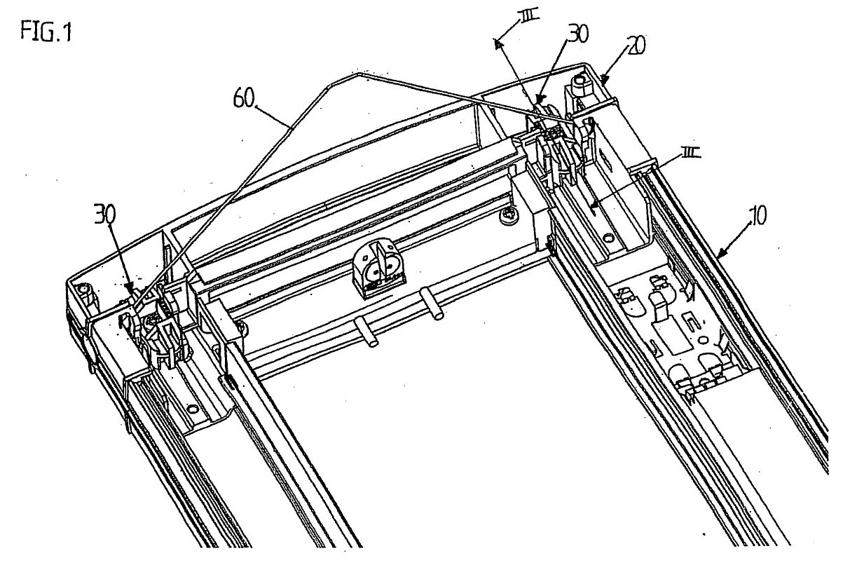

FIG. 1 shows a perspective plan view of the head end of a lamp housing,

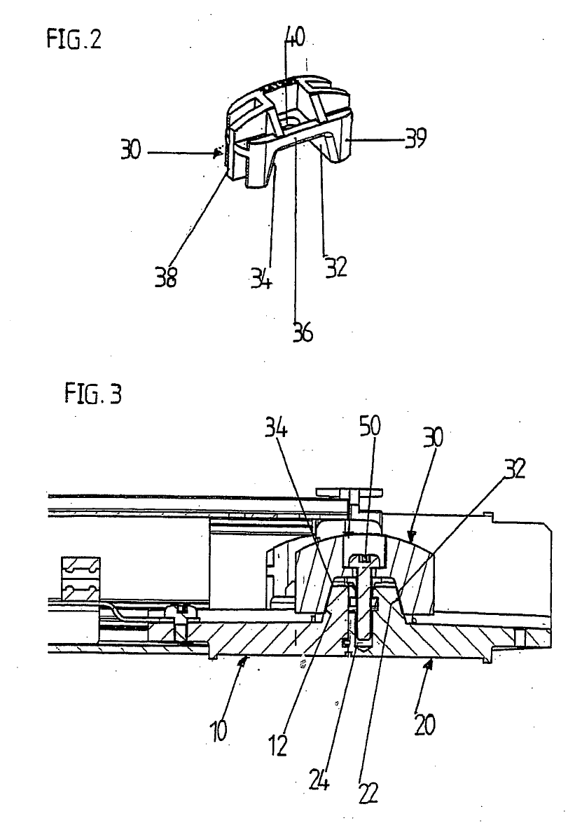

FIG. 2 shows a perspective view of the clamping portion according to the invention, and

FIG. 3 shows a portion on an enlarged scale through the lamp housing taken along line III-III in FIG. 1.

FIG. 1 shows a plan view of a lamp housing 10 which is in the form of a hanging lamp and to which a head portion 20 is fixed by means of two of the clamping portions 30 according to the invention.

The precise connecting configuration can be seen from FIG. 3. As shown therein the lamp housing 10 and the head portion 20 bear in area contact against each other at a perpendicular separation plane; to avoid transverse displacement, a tongue-and-groove connection is additionally provided between the lamp housing 10 and the head portion 20. That tongue-and-groove connection also provides a light-tight connection at the separation plane.

At the fixing location of the clamping portions 30 the lamp housing 10 and the head portion 20 each have respective contact pressure faces 12 and 22 which spread downwardly in the direction in which the clamping portion 30 is pushed on. The contact pressure faces in the assembled condition form a truncated pyramid.

In a configuration corresponding to the inclined contact pressure faces 12, 22 the clamping portion 30, on the inside, has mutually facing clamping contact pressure faces 32, 34 which extend inclinedly towards each other towards the upper end of the clamping portion 30, that is to say in the direction in which it is pushed on. The cut-out area within the clamping portion 30 is thus of a trapezoidal configuration with clamping contact pressure faces 32, 34 which converge inclinedly upwardly.

The clamping portion 30 is of a bridge-like structure. It comprises a connecting limb 36 which has contact pressing limbs 38, 39 which project from the connecting limb transversely with respect to the direction in which the connecting limb extends and in substantially mutually parallel relationship and which are formed in one piece thereon. The clamping contact pressure faces 32 and 34 which converge prismatically are provided on the mutually facing inward sides of the contact pressing limbs 38, 39. A through bore 40 is provided centrally in the connecting limb 36. A fixing screw 50 can be fitted into that through bore 40 and can be screwed into a screwthreaded bore 24 on the head portion 20. Alternatively that screwthreaded bore can also be provided on the lamp housing 10.

When the fixing screw 50 is screwed in, the clamping portion 30 is pushed with the clamping contact pressure faces 32, 34 on to the contact pressure faces 12, 22 of the lamp elements and in so doing presses the lamp housing 10 and the head portion 20 firmly against each other at the separation plane. Assembly can be effected easily from above and transversely with respect to the longitudinal direction of the lamp. In the assembly operation the fixing screw 50 is easily accessible from above as it extends in the separation plane or parallel thereto but at any event transversely relative to the longitudinal direction of the lamp.

As can be seen from FIGS. 1 and 3, provided in the end wall of the lamp housing 10 and the head portion 20 in the region of the assembly locations of the clamping portions 30 are openings which are in alignment with each other in the installation position and into which the clamping portions 30 can be inserted in the assembly operation so that the clamping portions 30 are sunk in the lamp housing 10 and the head portion 20.

As shown in FIG. 1, cable thimbles (not shown) of a mounting cable 60 for mounting the lamp as a hanging lamp are clamped between the lamp housing 10 and the head portion 20. In order to ensure the strength of the connection between the lamp housing 10 and the head portion 20, which is required from the safety point of view, the clamping portions 30 according to the invention are made from a 42CrMo4 steel alloy. Preferably the clamping portion is produced directly in the form shown in a perspective view in FIG. 2, in the form of a pressing with external stiffening ribs to increase the level of stiffness with at the same time a reduction in weight.

It will be apparent to the man skilled in the art that the clamping portion according to the invention, besides being suitable for lamp elements, is also suitable for fixedly connecting other components which bear in surface contact against each other.

### List of References

10 lamp housing
12 contact pressure face
20 head portion
22 contact pressure face
24 bore
30 clamping portion
32 clamping contact pressure face
34 clamping contact pressure face
36 connecting limb
38 contact pressing limb
39 contact pressing limb
40 through bore
50 fixing screw
60 mounting cable

1. Lamp elements which bear against each other at a separation plane and which can be releasably connected together by way of a connecting means, characterised in that the lamp elements are each provided with respective contact pressure faces and that the connecting means is in the form of a bridge-like clamping portion with clamping contact pressure faces which in the installation position bear against the contact pressure faces of the lamp elements and press the lamp elements against each other.

2. Lamp elements as set forth in claim 1 characterised in that the contact pressure faces of the lamp elements and the clamping contact pressure faces are of such a corresponding configuration that the clamping portion pulls the lamp elements against each other in the assembly operation.

3. Lamp elements as set forth in claim 2 characterised in that the contact pressure faces of the lamp elements widen prismatically—in the direction in which the clamping portion is pushed on—and the clamping contact pressure faces correspondingly narrow prismatically.

4. Lamp elements as set forth in claim 1 characterised in that the clamping portion comprises a material with a high level of tensile strength.

5. Lamp elements as set forth in claim 1 characterised in that they include openings at the separation plane for sinking the clamping portion.

6. Lamp elements as set forth in claim 1 characterised in that the clamping portion can be connected to a lamp element by way of a fixing screw.

7. A fixing means for connecting two lamp elements which bear against each other at a separation plane, characterised in that it is in the form of a bridge-like clamping portion with a connecting limb which at its ends has contact pressing limbs which project from the connecting limb transversely with respect to the longitudinal direction of the connecting limb and in substantially mutually parallel relationship, the contact pressing limbs having clamping contact pressure faces at the mutually facing inward sides.

8. A fixing means as set forth in claim 7 characterised in that the clamping contact pressure faces are of a prismatically tapering configuration in the push-on direction.

9. A fixing means as set forth in claim 7 characterised in that the clamping portion is made from a tough material, preferably 42CrMo4.

10. A fixing means as set forth in claim 7 characterised in that in the connecting limb the clamping portion has a through bore for a fixing screw.
